(19) United States
(12) Patent Application Publication
(10) Pub. No.: US 2014/0224096 A1
(43) Pub. Date: Aug. 14, 2014

(54) STRING SCORDATURA PEDALS

(71) Applicant: FRANK CARTER CALLISON, LONDON (GB)

(72) Inventor: FRANK CARTER CALLISON, LONDON (GB)

(21) Appl. No.: 14/174,060

(22) Filed: Feb. 6, 2014

Related U.S. Application Data
(60) Provisional application No. 61/764,627, filed on Feb. 14, 2013.

(51) Int. Cl. G10D 3/14

(52) U.S. Cl. CPC G10D 3/143
USPC 84/312 R

(57) ABSTRACT

A tuning device for a string instrument that allows a player to retune their individual strings by using a foot pedal. The foot pedal pivots vertically and horizontally and can be placed under a number of levers corresponding to the pitches which an instrument's string can be tuned. The pedal is attached to a bowden cable that is also connects to a tuning block located on the back of an instrument's tailpiece. The instrument's string attaches to the tuning block shuttle, which can move vertically along the back of the tailpiece. The mechanical force transferred from the pedal to the tuning block via the bowden cable results in the change of tension and consequently the change of pitch of the instrument's string.

### CROSS-REFERENCE TO RELATED APPLICATIONS

This application claims the benefit of U.S. Provisional Application No. 61/764,627, filed Feb. 14, 2013

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### JOINT RESEARCH AGREEMENT

Not Applicable

### BACKGROUND OF THE INVENTION

The present invention is in the technical field of Music. More particularly, the present invention is in the technical field of string playing. More particularly, the present invention is in the technical field of string retuning.

While prior art does exist in the field of string retuning, the specific attributes of the proposed invention have substantial differences and make significant improvements to other art in the field. Inventions such as U.S. Pat. No. 4,157,050A and U.S. Pat. No. 3,447,413A require multiple pedals to modify the pitch of a steel guitar string whereas the proposed invention utilizes a single pedal that can select numerous pitches for each string. Also, the proposed invention allows for the manual adjustment of a strings pitch at the tuning block in addition to modifying the pitch with a pedal. Furthermore, the flexible nature of the bowden cables and the simplicity of the other components of the proposed invention allows for it to be implemented more easily on a variety of different instruments.

### SUMMARY OF THE INVENTION

The present invention is a tuning block, tailpiece and pedals that attach to any string instrument. When a player presses a pedal with their foot, a single string on the instrument will retune to one of multiple predetermined pitches while the player is playing. Each pedal will manipulate the pitch of a different string. A player could use as many pedals as there are strings on their instrument. The pedals can also manipulate the pitch of each string by manually engaging a lever assembly without the need of the pedal(s). This invention allows composers and performers to employ natural harmonics that do not exist on the standard tunings of string instruments. In addition, having the ability to quickly retune a string will allow players to alleviate technical passages by offering alternative physical solutions for their performance.

### BRIEF DESCRIPTION OF THE DRAWINGS

FIG. 1 is a view of the tailpiece assembly, bowden cable assembly and multiple pedal assemblies connected to a string instrument (double bass).

FIG. 2 is a side view of a pedal assembly and its working components.

FIG. 3 is a partial view of the front of the pedal comprising the pulley system, bowden cable attachment, a side plate and pitch levers.

FIG. 4 is a side view of the pedal assembly with the top plate removed, exposing its underside and the hidden components connected to the bottom plate.

FIG. 5 is a partial and exploded view of the vertical pivot joint of the pedal.

FIG. 6 is a view of the pedal assembly from the rear.

FIG. 7 is a view of multiple pedals connected to each other.

FIG. 8 is an exploded view of the tuning block body, shuttle and cover along with their components.

FIG. 9 is a view of the tuning block body, shuttle and cover connected to one end of a bowden cable and to an instruments string.

FIG. 10 is a view of the pitch limiting assembly.

FIG. 11 is a view of the pitch limiting assembly mounted to components of the tuning block assembly.

FIG. 12 is a view of the entire tuning block assembly with its limiting lever attached.

FIG. 13 is a view of the back of the tailpiece.

FIG. 14 is a view of the front of the tailpiece with the tuning block assembly attach to the back.

FIG. 15 is a view of the back of the tailpiece with the tailpiece wire attached to the tailpiece hole.

### DETAILED DESCRIPTION OF THE INVENTION

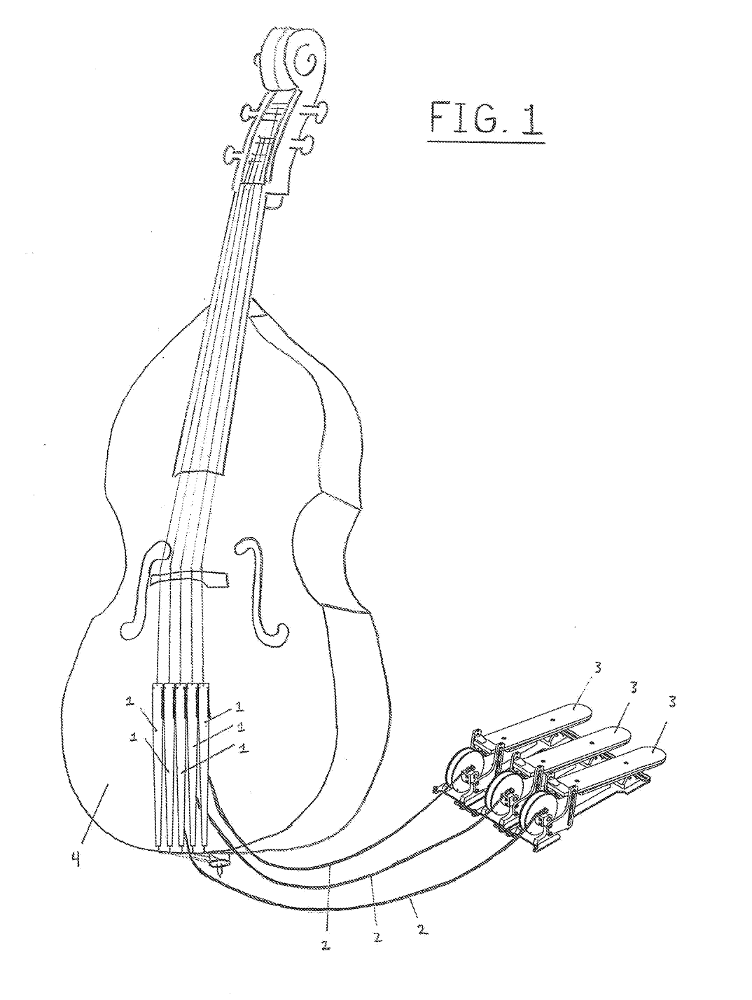

Referring now to the invention in more detail, FIG. 1 depicts the assembled components that comprise the tailpiece assembly (1), bowden cable assembly (2) and pedal assembly (3) that are connected to a string instrument (4). FIG. 1 is shown to give a global view of the invention.

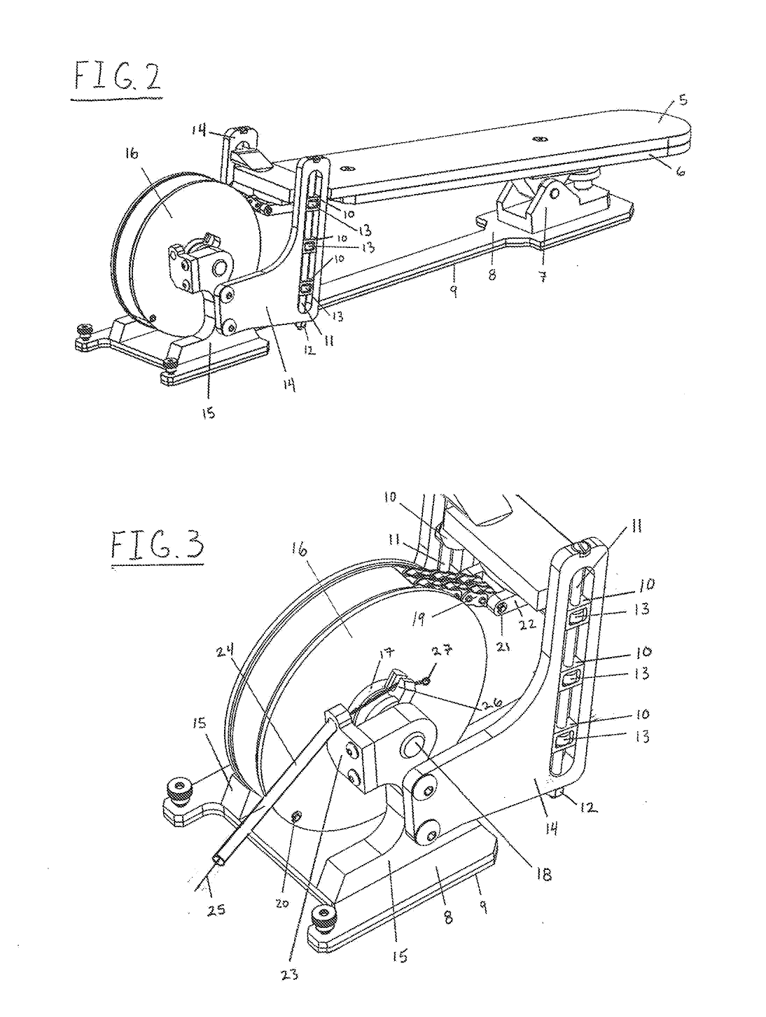

Referring now to the invention in more detail, FIG. 2 shows the components that make up the completed pedal assembly. The majority of components of the pedal assembly are made of metal such as aluminum unless otherwise noted. The foot platform of the pedal assembly is comprised of two pieces. The top plate (5) pivots horizontally and the bottom plate (6) pivots vertically. The vertical pivot is possible because of the connection of the bottom plate (6) to a hinge assembly (7) that is located at the rear of the base plate (8). Under the base plate (8) is the traction pad (9), which is made of rubber. The horizontal pivot of the top pedal plate (5) allows for it to be placed under pitch levers (10). The pitch levers (10) have a threaded bolt (11) going through their sides that is secured by a nut (12). A different nut with a cylindrical outer shape (13) is placed inside the pitch levers (10). The turning of the cylindrical nut makes the pitch levers (10) move up and down on the bolt (11), thus changing the locations where the top plate (5) can be placed under. These locations correspond to the different pitches an individual string on an instrument can be retuned to. The bolts (11) are attached to side plates (14). The side plates (14) are attached to pulley columns (15) to which a pulley wheel (16) is attached.

Referring now to the pulley system in more detail, FIG. 3 shows the pulley wheel (16) has a flanged sleeve bearing (17) at its core that is penetrated by a pulley shaft (18) that is supported by the pulley columns (15). The pulley wheel (16) is attached to a roller chain (19), which is held in place by a chain pin (20). The other side of the roller chain (19) is connected by another chain pin (21) to the chain mount (22). This chain mount (22) is bolted below the bottom plate (6) from FIG. 1.

Attached to one pulley column (15) is a housing mount (23) that keeps the bowden cable's housing (24) from passing through. The internal wire of the bowden cable (25) is threaded through the hole of the housing mount (23) and attaches on the side of the pulley wheel (16) at the nipple holder (26). The pedal nipple holder (26) keeps the bowden cable's nipple (27) from passing through and thus transfers mechanical force when the pedal is activated in conjunction with the undermentioned components of the invention.

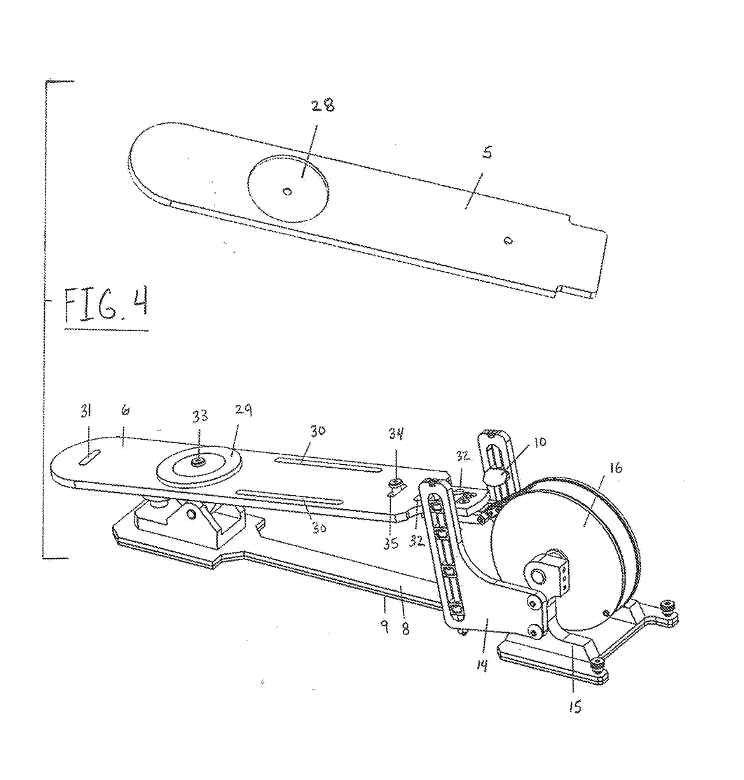

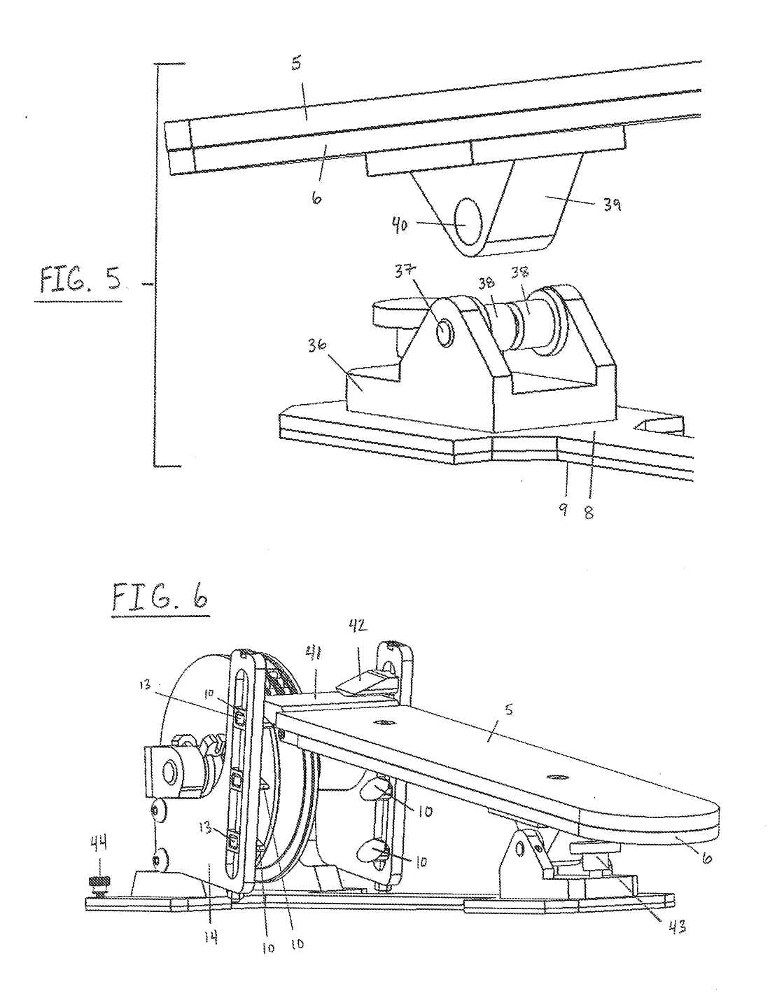

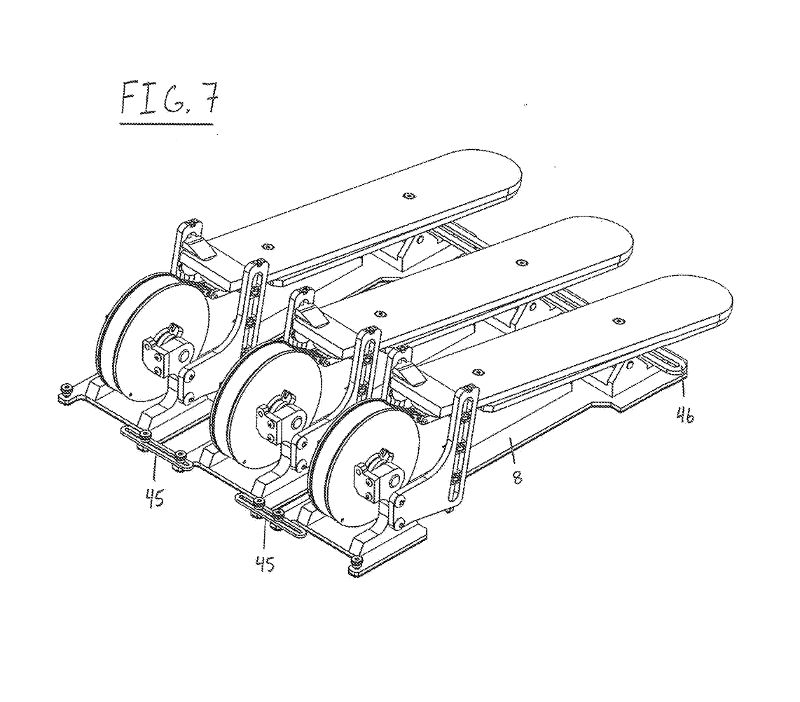

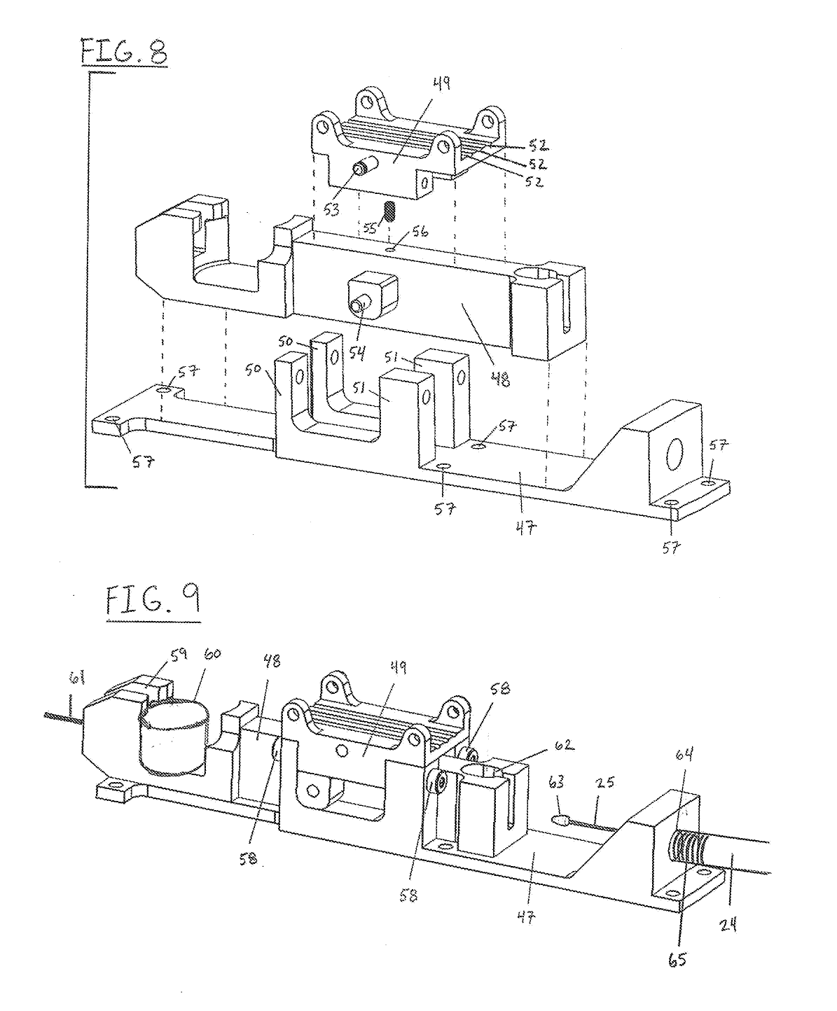

Referring now to the top plate (5) and bottom plate (6) in more detail, FIG. 4 shows the underside of the top plate (5) and the upper part of the bottom plate (6) that are hidden from view when assembled. A cylindrical space (28) is cut into the bottom of the top palate (5) to envelop the thrust bearing (29) fitted to the bottom plate (6). The thrust bearing helps accommodate the horizontal movement of the top plate (5) that a player engages. Also on the upper portion of the bottom plate (6) are two side grooves (30), one rear groove (31) and two upper grooves (32) that hold specifically sized pieces of plastic that slightly protrude above the grooves. This keeps the metal of the top plate (5) from rubbing against the bottom plate (6). The top plate (5) is held to the bottom plate (6) by a shoulder bolt (33) at the rear of the pedal. There is another shoulder bolt (34) at the top of the pedal that also keeps both plates (5 & 6) together. This shoulder bolt (34) has an elongated hole (35) that allows the top plate (5) and the bolt (34) to move horizontally while keeping both plates (5 & 6) connected.

Referring now to FIG. 5, a more detailed view of the pedal's hinge is shown. The bottom mount (36) is located at the rear of the base plate (8). The hinge shaft (37) runs through the bottom mount (36) and threads two flanged sleeve bearings (38). The top mount (39) is connected to the lower side of the bottom plate (6). The flanged sleeve bearings (38) and the hinge shaft (37) thread the hole (40) running through the top mount (39). This allows the pedals plates (5 & 6) to pivot vertically without creating undue friction.

Referring now to FIG. 6, a pedal toe cover (41) that is made of nylon plastic is placed over the tip of the top plate (5). This eliminates the metal of the top plate (5) from rubbing against the pitch levers (10) and also reduces noise. FIG. 6 also shows another view of the small pitch levers (10) and the single large pitch lever (42) connected to the side plates (14). The large pitch lever (42) is elongated so that the top plate (6) cannot be moved above the large pitch lever's underside. The small pitch levers (10) are located on adjacent side plates (14) and require the top plate (5) to move side to side in a zigzag pattern while the player engages the pedal up or down in order to select the desired pitch lever. Additionally, FIG. 6 shows a large screw (43) and a small screw (44). These screws are used to connect multiple pedals together.

Referring now to FIG. 7, a view of three pedals connected to each other is shown. Two small connector plates (45) are shown at the front of the base plate (8) and secure the pedals together by tightening the small screws (44). A large connecting plate (46) is shown at the rear of the pedal and connects the pedals in the same manner using the large screw (43) that is shown in FIG. 6.

Referring now to FIG. 8, we begin to look at the components that comprise the tuning block assembly, which attach to the pedal assembly by the bowden cable assembly. FIG. 8 shows the tuning block body (47), shuttle (48) and cover (49). The shuttle (48) fits between the tuning block body's upper arms (50) and lower arms (51) and is able to glide the length of the tuning block body (47) between the tuning block body arms (50 & 51). The shuttle (48) is held to the tuning block body (47) by the cover (49). The cover has three grooves (52) that run down its side and a rod (53) that goes through its side. The shuttle (48) also has a rod (54) going completely through its side. The rod (54) is held in place by a screw (55) that is tightened through a threaded hole (56) on the shuttle (48) top. At the top, middle and bottom of the tuning block body are holes (57) that allow it to be mounted to a tailpiece, which will be discussed in a later in FIG. 14.

FIG. 9 shows the tuning block body (47), shuttle (48) and cover (49) held together by screws (58). Located at the upper portion of the shuttle (48) is the string holder (59). This portion holds in place the ball end (60) of an instruments string (61) that the performer plays on. At the other end of the shuttle (48) is the shuttle nipple holder (62), which receives the nipple (63) from the opposite end of the bowden cable. At the bottom of the tuning block body is the body housing connector (64). This threaded hole receives the screw (65) attached to the end of the bowden cable housing (24). By turning the screw (65), the slack wire (25) in the bowden cable housing that is connected to the pedals is brought up to tension. Thus, when the pedal is engaged, the mechanical force created at the pedal will travel through the bowden cable and pull the shuttle (48), which modifies the pitch of the string.

Referring now to FIG. 10, we see the pitch limiting assembly. This consists of the pitch block (66) that has two threaded bolts (67) going through both sides. At the end of the bolts (67) are square shaped nuts (68) with protrusions (69) extending from the sides. As the head of the nut (70) is rotated, the nuts (68) glided up and down the cutout (71) that runs along the sides of the pitch block (66). A cap (72) is placed on top of the pitch block (66) to hold the head of the nut (70) in place. Located on the lower portion of the pitch block (66) are two cylindrical rods (73). The pitch block (66) is not fixed to the rods (73) so it can slide back and forth the length of the rod (73). At the bottom of the pitch block (66) there are two cylindrical holes (74) that receive a spring (75). At the end of the spring (75) is a ball (76) made out of acetal resin that will lock between the grooves (52) of the cover (49) that are shown in FIG. 8.

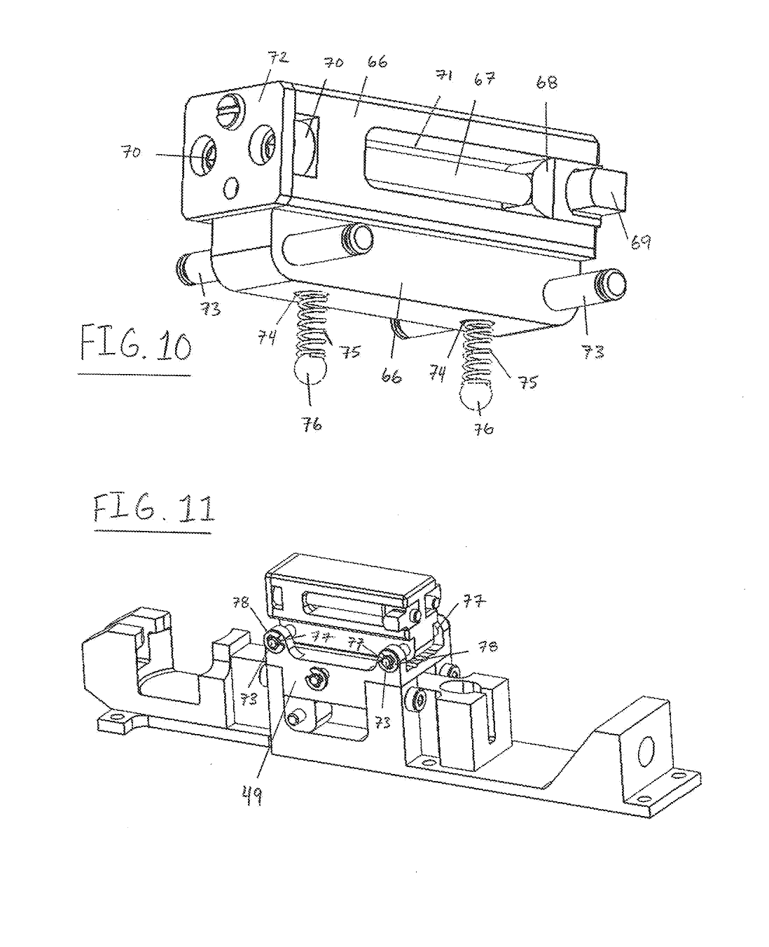

Referring now to FIG. 11, the pitch limiting assembly is connected to the cover (49) by securing the two rods (73) to the holes (77) on the sides of the cover (49). The rods (73) are held in place by grooved pins (78) that attach to the ends of the rods (73).

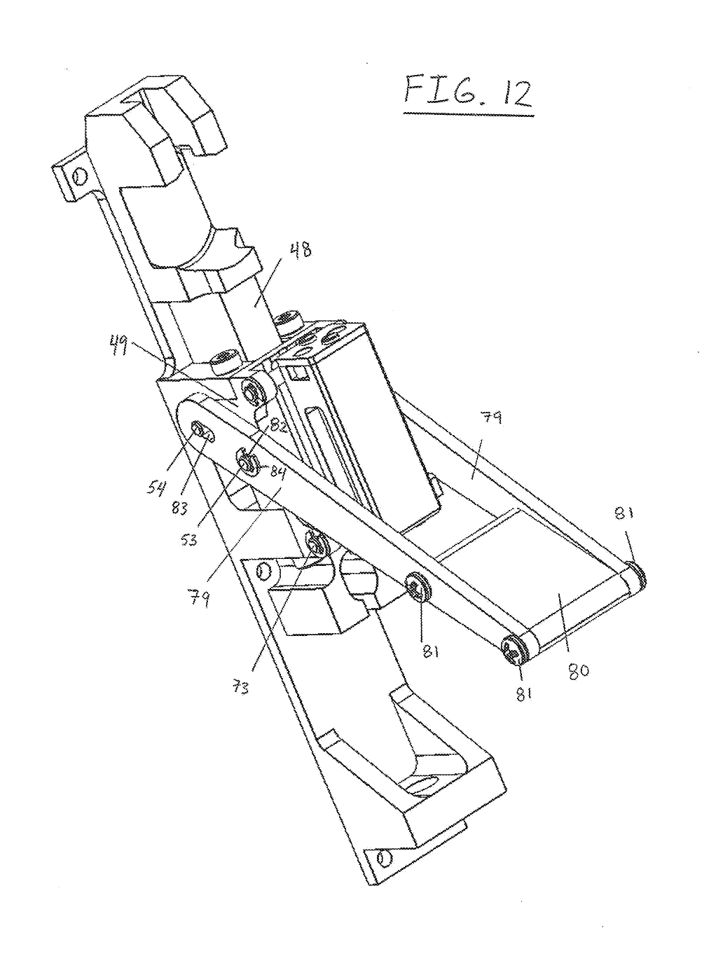

Referring now to FIG. 12, a lever assembly is shown attaching to the shuttle (48) and cover (49). The lever is made up of two arms (79) that connect to the thumb plate (80) by four screws (81). The levers have one small hole (82) and one elongated hole (83) that attach to the rod (53) that goes through the cover (49) and the rod (54) that goes through the shuttle (48). The rod (53) of the cover (49) is held in place by groves pins (84). When the lever is moved up or down, the shuttle (48) will move in the opposite direction, which will change the pitch of the instruments string. In order to lock the lever in place, the pitch limiting assembly is moved along its rods (73) to one side of the cover (49) and held in place by the acetal resin balls (76) in an outer groove (52) as discussed previously. This makes the lever arm (79) rest on one of the protrusions (69) of the square shaped nut (68), shown in FIG. 10, and limits the range the string can be tuned too. The lever assembly also allows pitches to be changed manually without the use of the pedal.

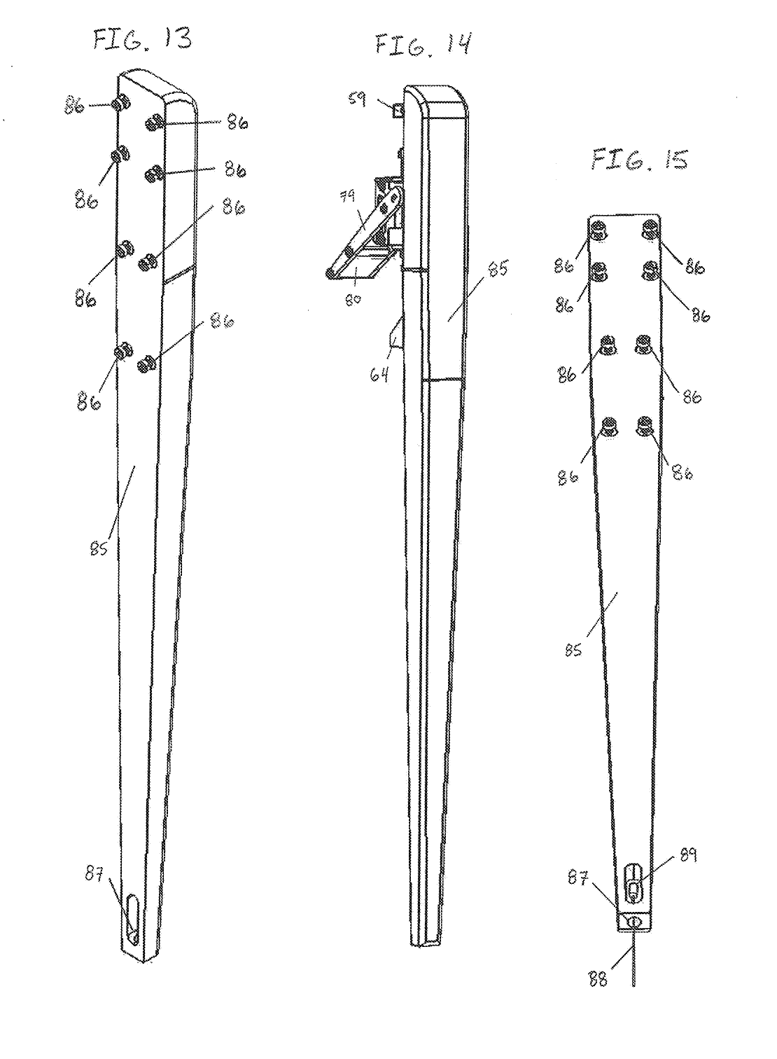

Referring now to FIG. 13, a tailpiece mount (85) is shown. The screws (86) on the tailpiece connect the tuning block assembly to it. A hole (87) is shown at the bottom that is used to connect the tailpiece to the body of the instrument.

Referring to FIG. 14, a view of the front of the tailpiece mount (85) is shown with the tuning block assembly connected to the back. The lever arms (79), thumb plate (80), string holder (59) and body housing connector (64) can also be seen.

Referring now to FIG. 15, a cable (88) is shown threading the hole (87) of the tailpiece mount (85). A ferrule (89) is placed at the end of the cable (88) to keep the cable (88) attached to the tailpiece mount (85). The other end of the cable (88) is secured to the body of the instrument at or near its endpin, depending on the specific characteristics of the instrument in question.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The embodiments of the invention in which an exclusive property or privilege is claimed are defined as follows:

1. An apparatus for retuning a string instrument, such as a double bass, comprising: a tailpiece assembly for mounting to the body of an instrument; tuning block assembly to mount the tailpiece assembly and connect to one string of said instrument; bowden cable assembly for connecting said tuning block assembly to a pedal assembly; and said pedal assembly to instigate the pitch change of said string by said tuning block.

2. The invention of claim 1 wherein said tailpiece assembly is comprised of a tailpiece and tailpiece wire.

3. The tailpiece assembly of claim 2 wherein said tailpiece wire attaches to the body of said string instrument.

4. The invention of claim 1 wherein said tuning block assembly is comprised of a tuning block body with a first and second end; a shuttle with a first, middle and second end; a cover; a limiting lever; and a pitch limiting assembly.

5. The tuning bock assembly of claim 4 wherein the first end of said shuttle consists of a string holder that connects to any string of said instrument.

6. The tuning bock assembly of claim 4 wherein the second end of said shuttle consists of a shuttle nipple holder.

7. The tuning bock assembly of claim 4 wherein the second end of said tuning block body consists of a body housing connecter.

8. The tuning bock assembly of claim 4 wherein said shuttle slides the length of said tuning block body between the arms of said tuning block body while being held in place by the cover and said pitch limiting assembly mounts to the top of said cover and slides across said cover on two rods.

9. The tuning bock assembly of claim 4 wherein said limiting lever is attached to said middle of said shuttle and said cover and is limited in motion by the interference of said pitch limiting assembly when it is engaged.

10. The invention of claim 1 wherein said pedal assembly comprises of a foot pedal with a first and second end; a base plate with a first and second end; a pulley system with a right and left side;
two side plates; and multiple pitch levers.

11. The pedal assembly of claim 10 wherein said first end of said base plate connects to said first end of said foot pedal; said pulley system attaches to said second end of said base plate and said second end of said foot pedal; and said side plates attach to both right and left sides of said pulley system and connect to said pitch levers.

12. The pedal assembly of claim 10 wherein said pulley system comprises of two pulley columns; a housing mount; pulley wheel; pulley shaft; and two flanged sleeve bearings.

13. The pulley system of claim 12 wherein said pulley wheel connects to said flanged sleeve bearings at center of said pulley wheel.

14. The pulley system of claim 12 wherein said pulley shaft penetrates said pulley wheel and said flanged sleeve bearings.

15. The pulley system of claim 12 wherein said pulley columns attach to the second end of said base plate.

16. The pulley system of claim 12 wherein said pulley columns suspend said pulley shaft.

17. The pulley system of claim 12 wherein said pulley wheel further comprises of a pedal nipple holder on one side of said wheel above said pulley shaft.

18. The pulley system of claim 12 wherein said housing mount attaches to said pulley column.

19. The invention of claim 1 wherein said bowden cable assembly, with a first and second end, is further comprised of cable housing; an internal wire; cable nipples on both ends of said internal wire; and a threaded screw over the end of said housing at said first end.

20. The bowden cable assembly of claim 19 wherein said cable nipple at first end of said bowden cable assembly passes through said body housing connecter and is placed inside said shuttle nipple holder.

21. The bowden cable assembly of claim 19 wherein said threaded screw at first end of said housing attaches to said body housing connecter, thus connecting said tuning block assembly with first end of said bowden cable assembly.

22. The bowden cable assembly of claim 19 wherein said cable nipple at second end of said bowden cable assembly passes through the hole of said housing mount and secures behind said pedal nipple holder on said pulley wheel, thus connecting said pedal assembly to the second end of said bowden cable assembly.

23. The pitch limiting assembly of claim 4 wherein said pitch limiting assembly is held against said cover by a spring loaded ball that locks between the grooves on said cover.

24. The grooves recited in claim 23 wherein said grooves consist of two outer grooves and one middle groove.

25. The pitch limiting assembly of claim 4 wherein said pitch limiting assembly further comprises of a pitch block with two threaded bolts going through both sides.

26. The pitch limiting assembly of claim 25 wherein said bolts attach to square nuts with protrusions that extend from the side of said square nuts.

27. The square nuts recited in claim 26 wherein said square nuts travel the length of said bolt in a cutout on both sides of said pitch block.

28. The tuning block assembly recited in claim 9 wherein said pitch limiting assembly is engaged, and therefore interferes with the motion of said limiting lever, only when said pitch limiting assembly is locked into said outer grooves.

29. The tuning block assembly recited in claim 9 wherein said pitch limiting assembly is not engaged, and therefore does not interfere with the motion of said limiting lever, only when said pitch limiting assembly is locked into said middle groove.

30. The tuning block assembly recited in claim 9 wherein the manual engagement, or lack thereof, of said pitch limiting assembly enables the selection of up to three different pitches on said string on said instrument without the use of said pedal assembly.

31. The pedal assembly recited in claim 10 wherein said foot pedal consists of a top plate and a bottom plate.

32. The foot pedal recited in claim 31 wherein said top plate pivots horizontally on a thrust bearing attached to the bottom plate.

33. The foot pedal recited in claim 31 wherein said bottom plate pivots vertically on two flanged sleeve bearings attached to said first end of said base plate.

34. The foot pedal recited in claim 31 wherein said second end of said bottom plate is bolted to a chain mount.

35. The chain mount recited in claim 34 wherein a roller chain with a first and second end connects to said chain mount at first end.

36. The roller chain recited in claim 35 wherein said second end of said roller chain connects to said pulley wheel.

37. The side plates of claim 10 wherein said side plates have a cutout in the shape of a rectangle with rounded corners running the length of said side plates.

38. The cutouts recited in claim 37 wherein said cutouts have a threaded bolt going through the length of the cutout.

39. The bolt recited in claim 38 wherein said pitch levers are connected to said bolt.

40. The pitch levers recited in claim 39 wherein said pitch levers further comprise of an internal cylindrical nut that is threaded to said bolt allowing said pitch levers to move up and down the length of said bolt.

41. The pitch levers recited in claim 40 wherein said pitch levers restrict the vertical motion of said foot pedal by allowing said top plate of said foot pedal to be placed under said pitch levers.

42. The foot pedal recited in claim 41 wherein said top plate of said foot pedal zigzags between said pitch levers mounted on said side plates.

43. The zigzag motion recited in claim 42 which consists of the vertical motion of said bottom plate while simultaneously instigating the horizontal pivot of said top plate wherein said motion allows for the movement of said foot pedal up and down the space between said side plates attached to said pitch levers.

44. The said top plate recited in claim 31 wherein said second end of top plate is covered by a toe cover to eliminate the metal of said top plate from contacting the metal of said pitch levers.

45. The apparatus describe in claim 1, wherein said tuning block can be connected directly to the body said instrument without the use of said tailpiece assembly depending on the individual characteristics of said instrument.
